(19) United States
(12) Patent Application Publication
(10) Pub. No.: US 2008/0127183 A1
(43) Pub. Date: May 29, 2008

(54) Document Workflows and Routing Services Using Modular Filters

(75) Inventors: Daniel Emerson, Redmond, WA (US); Khaled Sedky, Sammamish, WA (US); Victoria E. Milton, Woodinville, WA (US); Feng Yue, Sammamish, WA (US); Andrew R. Simonds, Newcastle, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/563,584

(22) Filed: Nov. 27, 2006

(51) Int. Cl. G06F 9/46

(52) U.S. Cl. 718/100

(57) ABSTRACT

Systems, methods, and/or techniques (“tools”) for providing document workflows and routing services using modular filters are described. In some aspects, the tools may initiate a workflow from a first modular processing filter within a pipeline of modular processing filters. The pipeline may be included within a device driver. The tools may also process the workflow using at least a second processing filter provided within the pipeline.

### BACKGROUND

As new types of document peripherals become available in the market, enterprises or other users of these devices are continually integrating these new devices into workflows. Typically, these devices may serve as sources or destinations of document data in workflows. However, as these devices become more advanced, they may provide more storage, processing, and other features on-board the device. Therefore, opportunities exist for integrating these devices into workflows more effectively and more efficiently.

### SUMMARY

Systems, methods, and/or techniques (“tools”) for document workflows and routing services using modular filters are provided. In some aspects, the tools may initiate a workflow from a first modular processing filter within a pipeline of modular processing filters. The pipeline may be implemented within a device driver. The tools may also process the workflow using at least a second processing filter provided within the pipeline.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “tools,” for instance, may refer to system(s), method(s), computer-readable instructions, and/or technique(s) as permitted by the context above and throughout the document.

### BRIEF DESCRIPTIONS OF THE DRAWINGS

Tools related to document workflows and routing services using modular filters are described in connection with the following drawing figures. The same numbers are used throughout the disclosure and figures to reference like components and features. The first digit in a reference number indicates the drawing figure in which that reference number is introduced.

FIG. 1 is a combined block and flow diagram of operating environments for document workflows and routing services using modular filters.

FIG. 2 is a block diagram of a data structure related to document containers and ticket packages described as part of the tools for document workflows and routing services using modular filters.

FIG. 3 is a combined block and flow diagram of a workflow arrangement in which one of the modular processing filters initiates a workflow, and then the workflow reports or communicates back to the initiating filter after the workflow completes.

FIG. 4 is a combined block and flow diagram of a workflow arrangement in which one of the modular processing filters initiates a workflow, with the workflow and the filter then proceeding independently and in parallel afterwards.

FIG. 5 is a combined block and flow diagram of a workflow arrangement in which an ongoing workflow initiates a filter pipeline, and in turn, the filter pipeline initiates one or more secondary workflows.

FIG. 6 is a combined block and flow diagram of additional illustrative operating environments for performing document workflows and routing services using modular filters.

### DETAILED DESCRIPTION

### Overview

The following document describes tools capable of performing and/or supporting many techniques and processes. The following discussion describes exemplary ways in which the tools provide for document workflows and routing services using modular filters. This discussion also describes other techniques and/or processes that the tools may perform. Using the techniques described herein, the peripheral devices may act as intermediary nodes in workflows, in addition to acting as starting points or ending points in the workflows.

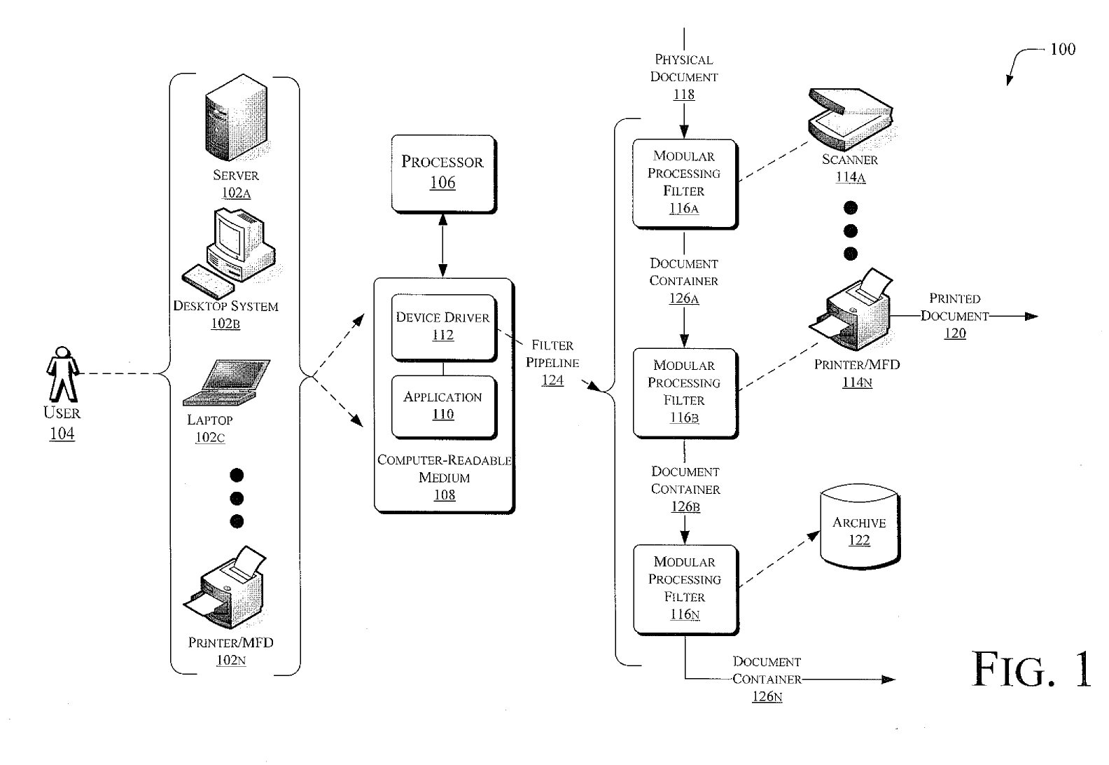

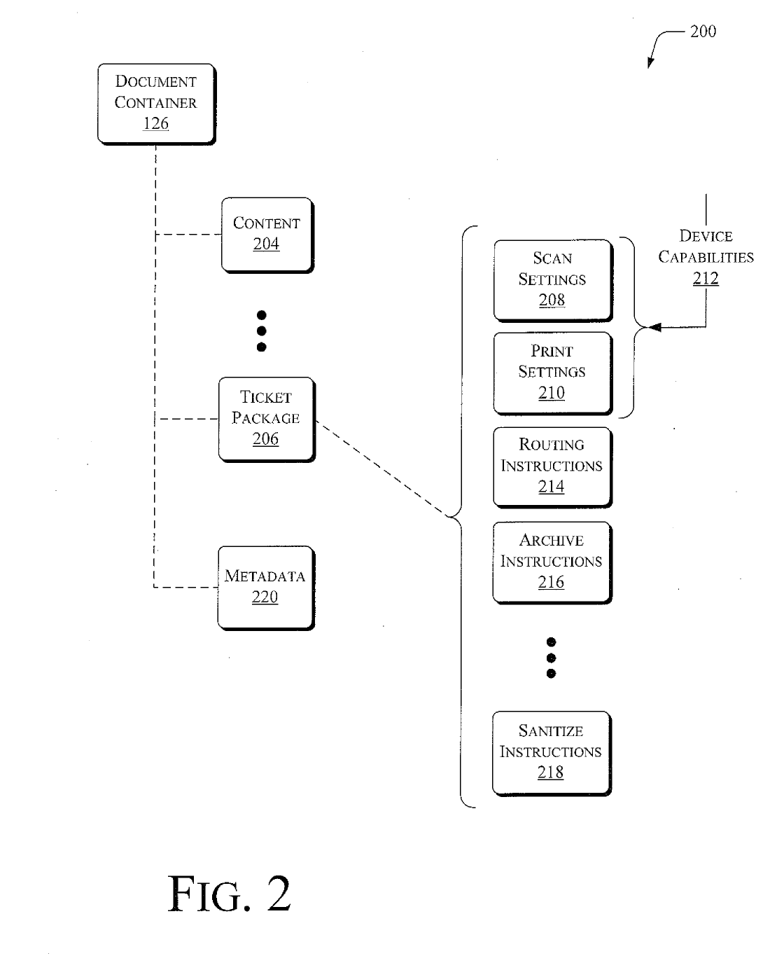

FIG. 1 illustrates operating environments 100 for document workflows and routing services using modular filters. The operating environments 100 may include one or more devices, such servers 102a, desktop computing systems 102b, laptop or notebook computing systems 102c, multifunction devices (MFDs) 102n, or the like. It is understood that implementations of the operating environment may include any number of different types of such devices (collectively, devices 102). Additionally, FIG. 1 shows these examples of such devices only for convenience of illustration, but not to limit possible implementations.

One or more users 104 may be associated with the devices 102. As described in further detail below, these users 104 may initiate jobs or workflows, or may participate in existing workflows. To perform such functions, these users may interact with one or more of the devices 102. For ease of description, but not limitation, the users 104 and/or the devices 102 may be viewed as clients that nay request services.

In general, the devices 102 may be computer-based systems that include one or more processors, denoted at 106. These processors may also be categorized or characterized as having a given type or architecture, but may or may not have the same type or architecture.

The devices 102 may also include one or more instances of machine-readable or computer-readable storage media, denoted generally at 108. The computer-readable media 108 may contain instructions that, when executed by the processor 106, perform any of the tools or related functions as described herein. The processor may be configured to access and/or execute the instructions embedded or encoded onto the computer-readable media.

Turning in more detail to the computer-readable media 108 it may include one or more applications 110. These applications 110 may include, for example, word processing applications, database applications, image processing or editing applications, browsers, or the like. In general, the users 104 may interact with the applications using resources provided by the devices 102.

The computer-readable media 108 may also include one or more instances of a device driver 112. Respective device drivers may be associated with devices that may support work flows, such as a scanner 114a, a printer or multi-function device (MFD) 114n, or the like (collectively, devices 114). FIG. 1 shows the scanner and the MFD only for ease of description, but not to limit possible implementations of the operating environment 100. The user 104 may access functions provided by the devices 114 by, for example, interacting with the application 110, which in turn may cooperate with the appropriate device driver 112 for the device. The devices 114 may also include processors and computer-readable media, similar to those referenced at 106 and 108, and the description of these aspects of the devices 102 may apply equally to the devices 114. The devices 114 may include user interfaces on their front panels, enabling the users 104 to interact directly with the devices 114.

Assume, for example, that a particular user 104 wishes to use one of the devices 114 to perform one or more given jobs or tasks. Examples of such tasks may include scanning, faxing, printing, archiving, workflow routing, or the like. In some instances, the user may setup and control multiple sub-tasks to be performed as part of a given job using, for example, the ticket package mechanism described below. To initiate this job, the user may issue appropriate commands to the application 110. These commands may include, for example, scanning commands, printing commands, or the like, as may be entered on any of the devices 102 and/or 114. More specifically, the commands may relate to obtaining the capabilities of the devices 114. In the illustrated implementation, the application 110 may refer these commands from the users 104 to the device driver 112.

The device driver 112 may implement a pipeline of respective modular processing filters. For example only, FIG. 1 shows three examples of the filters, denoted at 116a, 116b, and 116n (collectively, filters 116). However, implementations of the operating environment 100 may include any number of filters 116. These filters may implement respective functions, and pipelines of these filters may be assembled to perform any functions or workflows requested by the user 104. In an example workflow, the filter 116a may be an input filter that scans physical documents, represented generally at 118, into electronic form using the scanner 114a. Continuing this workflow, the filter 116b may be a printing filter that prints hardcopies of electronic documents using the MFD 114n, with these printed documents represented at 120. Finally, the filter 116n may be an archive filter that stores the documents in an archive 122 for later retrieval.

It is noted that the filters 116 may execute on the devices 102 or the devices 114, as appropriate, considering the resources available on these different devices. For example, input/output devices, such as the scanner 114 and/or the MFD 114n, may include hard disk storage and may execute an operating system locally at the device. In such instances, one or more of the filters 116 may execute locally on the input/output devices 114, while other filters may execute on the devices 102. In other instances, all of the filters may execute on the devices 102.

FIG. 1 represents the filter pipeline generally at 124. It is noted that the device drivers 112 and the filter pipeline 124 (or more generally, filters) are shown separately only for ease of reference and convenience of discussion, but not to limit possible implementations. In some instances, filters may run on the printer/scanner devices (e.g., 114a-n), while device drivers running on devices (e.g., 102) may send jobs or requests to the printer/scanner devices. In these cases, the filters and the device drivers may be separate entities. However, in other instances, the filters may run on the devices 102, along with the device drivers 112. In these latter cases, the filters may be part of the device drivers.

As documents move through the filter pipeline 124, content within those documents may be transported in document containers 126. Returning to the example workflow introduced above, a document container 126a may store at least the document content as sourced from the scanner 114a. A document container 126b may contain the document content as it is to be archived. Finally, a document container 126n may contain document content as it may be passed to subsequent filters for additional processing.

Having described the operating environments 100, the discussion now turns to a description of document containers and ticket packages, now presented with FIG. 2.

FIG. 2 illustrates a block diagram of a data structure 200 related to ticket packages and document containers described as part of the tools for document workflows and routing services using modular filters. For convenience of description, but not to limit possible implementations, some items described previously are carried forward into FIG. 2 and denoted by similar reference signs.

A given instance of a workflow may be associated with a document container structure 126. The document container structure may include a content field 204 that contains content related to the given workflow, or a particular job performed within that workflow. For example, if the job relates to scanning a document, then the content field may contain image data representing the scanned document. If the job relates to printing a document, then the content field may contain printable data representing the printable document.

The document container structure may also contain a ticket package element 206. The ticket package element may enable the user to setup and control multiple jobs (e.g., scan, then print, then archive) within a workflow, using a single ticket package stored within the document container 126.

For convenience of description, but not limitation, an example of an XML implementation of the ticket package element 206 is produced here. The ticket package element allows multiple device function settings to be included in, for example only, an XML document, as illustrated below:

```
<schema1:DeviceTicket>
    <schema1:ScanTicket>
    ...
    </schema1:ScanTicket>
    <schema1:PrintTicket>
    ...
    </schema1:PrintTicket>
    <schema2:RoutingTicket>
    ...
    </schema2:RoutingTicket>
    <schema3:ArchiveTicket>
    ...
    </schema3:ArchiveTicket>
    ...
    <schemaN:FunctionNTicket>
    ...
    </schemaN:FunctionNTicket>
    ...
    <schemaZ:SanitizeTicket>
    ...
    </schemaZ:SanitizeTicket>
</schema1:DeviceTicket>
```

In this example, a <DeviceTicket> root XML element is defined under which multiple <FunctionTicket> XML child elements may be defined. The term “DeviceTicket” is used herein for convenience only, but not limitation. Specifically, a given device may provide some, but not all, of the functions described in the example above. The ticket package may thus apply across a given workflow. In turn, the workflow may involve multiple devices. The root <DeviceTicket> represents an entire given workflow, while each child element represents a specific function performed within the workflow. In this example, the <DeviceTicket> defines printing and scanning functions under a first schema (“schema1”), while also defining an arbitrary example function <FunctionNTicket> under a different schema (“schemaN”). In this manner different <FunctionTicket> elements may be defined in different schemas for processing as defined by the namespace of the <DeviceTicket> element.

Turning to the contents of the ticket package 206, this element may specify different parameters relating to the work flow that the user wishes to perform. For example, the ticket package 206 may include any number of settings that are specific to particular devices, such as the devices 106. FIG. 2 shows a non-limiting example that includes a scan settings field 208 and a print settings field 210. In general, these device-specific settings may be defined based on device capabilities 212. For example, an MFD 106N may advertise device capabilities that include a variety of different functions, while supporting different parameters applicable to these different functions. The user 104 may review these different functions and applicable parameters, and specify any particular functions and/or parameters that are of interest, through the ticket package 206.

The term “device capabilities” is used herein for convenience, but not limitation. More specifically, capabilities as reported by particular devices may be incorporated into a ticket package that is passed to a workflow. This workflow may be passed to a variety of different devices, with different devices performing different functions that are specified in the ticket package. Thus, a given device may report the capabilities that it may contribute to a potential workflow, and a ticket package for this potential workflow may incorporate these device capabilities, among other items. This potential workflow may be passed to the given device. However, the given device might not perform each capability specified in the ticket package, but instead may perform only some of the capabilities expressed in the ticket package.

In possible implementations, the device capabilities 212 may be specified in, for example, a XML document as illustrated in the example below:

```
<schema1:DeviceCapabilities>
    <schema1:PrintCapabilities>
    ...
    </schema1:PrintCapabilities>
    <schema1:ScanCapabilities>
    ...
    </schemaN:FunctionNCapabilities>
</schema1:DeviceCapabilities>
```

In this example, the device capabilities document defines a <DeviceCapabilities> root XML element, along with multiple <FunctionCapabilities> XML child elements. The <DeviceCapabilities> represents an entire device (e.g., at 114 in FIG. 1), while each child element represents a specific function of the device. Each <FunctionCapabilities> child element may be defined in a different schema for processing as defined by the namespace of the child element. In this example, the device capabilities document defines print capabilities and scan capabilities under a first schema (“schema1”), and defines an arbitrary example function under a second schema (“schemaN”).

The processing of this device capabilities document may be exposed through one or more APIs. Using these APIs, the device driver 112 may provide a single mechanism for the application 110 to query the “capabilities package” for devices 114 (e.g., the MFD 114n). Some implementations may also include separate APIs to independently query each function contained in a “capabilities package”. For example, an application could query only the <PrintCapabilities> for a multi-function device that supports print and scan functions.

The ticket package 206 may also include a routing instructions field 214 that specifies the devices, components and/or processes to which the given workflow is to be routed. For example, if a given document is to be scanned in to initiate a workflow, then the user 104 may specify that the document is to be reviewed and approved by a human or automated compliance entity at some point in the workflow. The routing instructions field 214 may specify who is to review and approve the workflow or the document.

The ticket package 206 may also include an archiving instructions field 216 that specifies whether one or more documents involved in a workflow are to be archived. If the document is to be archived, then the archiving instructions may specify when or how often to archive the document, as well as how to archive the document.

The ticket package 206 may also include a sanitize instructions field 218 that specifies whether one or more documents involved in a workflow are to be released outside of a given organization. If the documents may be released externally, then the sanitize instructions field 218 may further specify any portions of the documents that are to be removed, obscured, or otherwise sanitized before the documents are released. For example, any confidential or sensitive information may be removed before externally releasing the document. In some instances, the sanitize instructions field 218 may specify that certain documents are for internal use only, and not for external release.

During the course of a given workflow, the workflow may generate metadata. The document container 126 may store this generated metadata in a metadata field 220. For example, the metadata may provide a history of a given workflow. In some instances, the metadata may indicate which workflow components or devices were involved with the workflow. The metadata may also indicate when these components or devices participated in the workflow. More generally, the metadata may store any arbitrary information about the job or the content in the job, including the workflow history described above. Other examples of metadata 220 may include job-related statistics, such as: the number of documents in the job; the number of pages in a given document: the times at which documents are printed or scanned; the times that virus checks have been run; general document information, such the author of the document, the times that the document was created, modified, accessed, or the like.

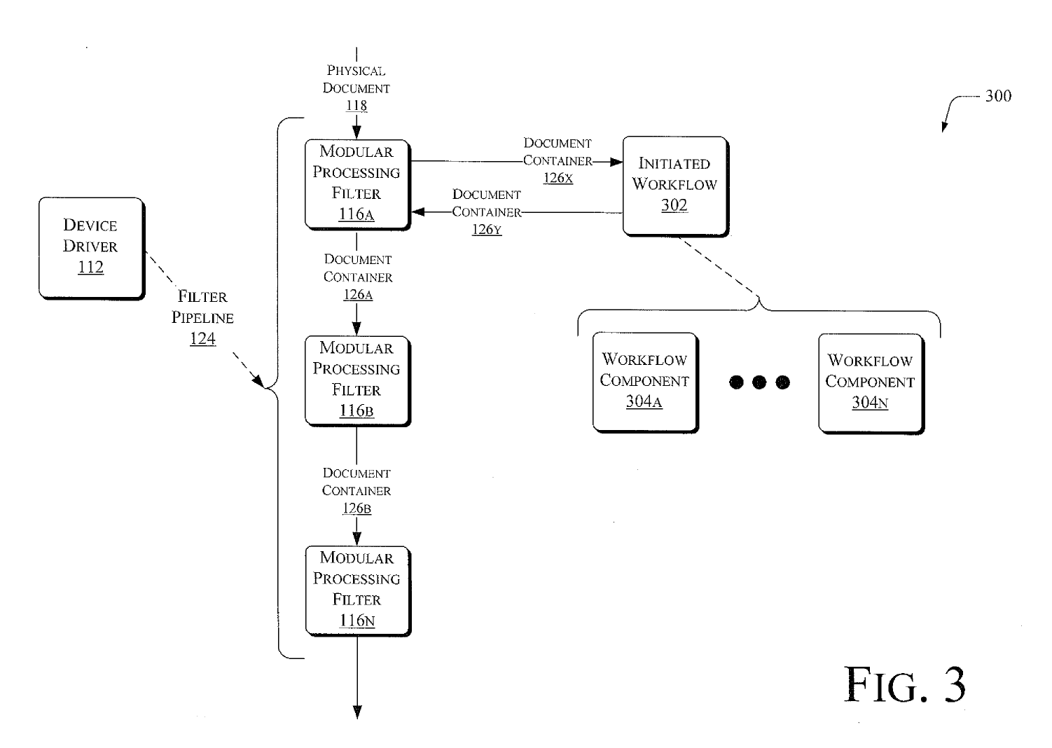

Having described the document containers ticket packages and in FIG. 2, the discussion now proceeds to a description of illustrative workflows that may be performed in connection with the modular processing filters, now presented in FIG. 3.

FIG. 3 illustrates a combined block and flow diagram 300 related to a workflow arrangement in which a modular processing filter initiates a workflow, and then the workflow reports back to the initiating filter after the workflow completes. For convenience of description, but not to limit possible implementations, some items described previously are carried forward into FIG. 3 and denoted by similar reference signs.

In the example shown in FIG. 3, a given modular processing filter, represented generally at 116a, may spawn or initiate a workflow. FIG. 3 represents this workflow generally at 302. This workflow 302 may include one or more components, represented generally at 304. FIG. 3 shows two example workflow components at 304a and 304n, but implementations could include any number of workflow components.

In the example workflow shown in FIG. 3, the workflow 302 receives a document container, denoted at 126x, from the modular processing filter 116a that initiated the workflow. After the workflow 302 completes, it may return a document container 126y. In this manner, the modular processing filter initiates the workflow, then awaits completion of the workflow before proceeding with the next modular processing filter (e.g., 116b).

For ease of illustration, but not limitation, assume that the modular processing filter 116a is associated with a scanner, and that the scanner receives a physical document 118 for sourcing. The document container 126a may store the scanned content. However, before passing the document container 126a to subsequent filters, the filter 116a may pass the scanned content to the workflow 302, within the document container 126x. For example, the workflow 302 may involve determining additional material, such as a header, footer, legend, banner, watermark, or the like to be embedded in the scanned content. In some instances, this additional material may indicate whether the content is proprietary, confidential, or sensitive. In other instance, this additional material may indicate a date and time at which the content was scanned, and/or who scanned the content.

In this example, a first workflow component (e.g., 304a) may select the additional material or content to be embedded in the scanned content. In some instances, the user may specify this additional material or content. In other instances, this selection may be governed by business logic or rules. Having selected what additional material to be embedded in the scanned content, another workflow component (e.g., 304n) may embed the selected material into the scanned content. Afterwards, the scanned content as embedded with this additional material may be passed back to the filter 116a using the document container 126y,

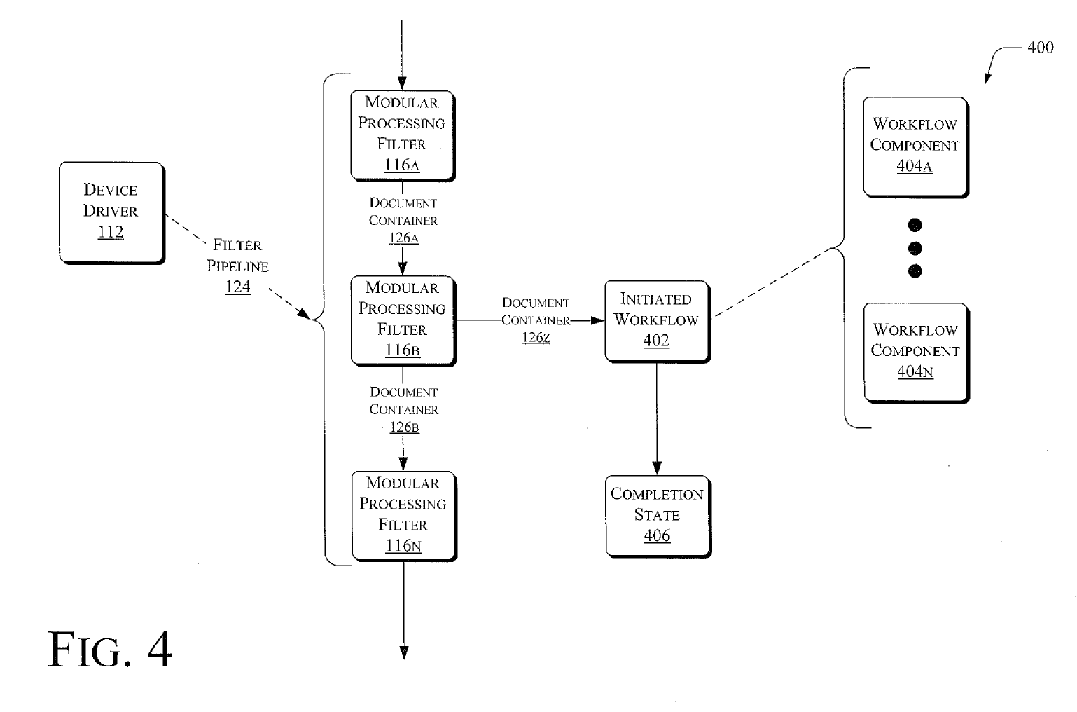

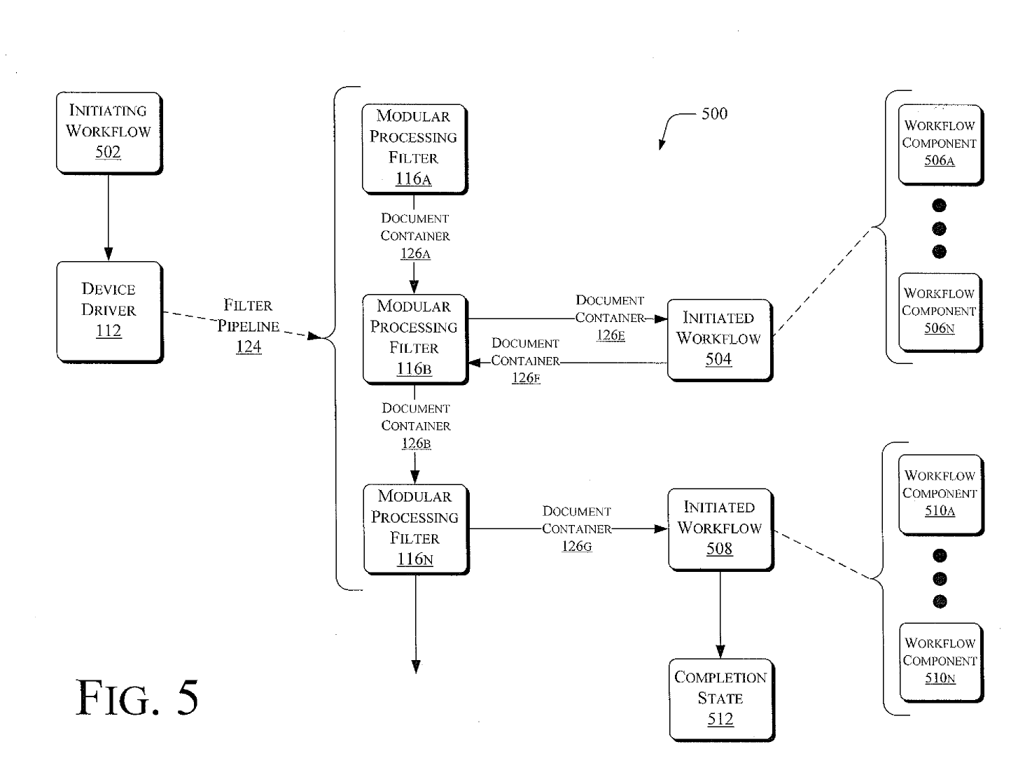

In any event, the implementation shown in FIG. 3 illustrates a scenario in which the filter 116a may await completion of the workflow 302 before proceeding with the next-filter 116b. However, other implementations are possible, as now shown in FIGS. 4 and 5.

In another example implementation, one of the filters 116 may recognize a triggering event, and instantiate or initiate a workflow 302 in response to this triggering event. For example, content being processed by one of the filters may trigger the new workflow. In one instance, the presence of an image may trigger a new workflow related to image processing. In another instance, a filter may recognize one or more keywords in the ticket package, and initiate a new workflow that processes the content for compliance with corporate procedures. For these examples, the workflow 302 may include routing the content for legal, executive, or management approval before proceeding further with the filters. Additionally, filters may initiate new workflows in response to entries in the metadata repository (e.g., 220 in FIG. 2). In different implementations, this approval process may involve human actors or automated processes.

FIG. 4 illustrates a combined block and flow diagram 400 related to a workflow arrangement in which a modular processing filter initiates a workflow, and the workflow and the filter then proceed independently and in parallel. For convenience of description, but not to limit possible implementations, some items described previously are carried forward into FIG. 4 and denoted by similar reference signs.

In the example shown in FIG. 4, a given modular processing filter, represented generally at 116b, may spawn or initiate a workflow. FIG. 4 represents this workflow generally at 402. This workflow 402 may include one or more components, represented generally at 404. FIG. 4 shows two example workflow components at 404a and 404n, but implementations could include any number of workflow components.

In the example workflow shown in FIG. 4, the workflow 402 receives a document container, denoted at 126z, from the modular processing filter 116b that initiated the workflow. However, the workflow 402 may proceed to completion independently of the processing filters 116. For example, after initiating the workflow 402, the processing filter 116b may proceed to the next filter 116n without awaiting the completion of the workflow 402. In this manner, the workflow 402 may proceed in parallel with the filters 116.

Examples of the workflow 402 may include sending a document to a monitoring process that emails the document to a set of users, based on information contained within the document. Other examples may include sending the input document to an archive, or posting the document to a web site document repository. Another example may include an enterprise auditing the types of documents that enter the electronic workflow to better plan for future enterprise infrastructure. Finally, an input or an output document could be sent to a workflow that processes the document to categorize the content within (e.g., number of pages, color or black-and-white, number of images, or the like).

For convenience, FIG. 4 illustrates a completion state 406 for the workflow 402. Once the workflow 402 reaches this completion state 406, the workflow may end without reporting back to the processing filter 116b that initiated the workflow, or to any other processing filter 116.

FIG. 5 illustrates a combined block and flow diagram 500 related to a workflow arrangement in which a workflow initiates a filter pipeline, and in turn, the filter pipeline initiates one or more secondary workflows. For convenience of description, but not to limit possible implementations, some items described previously are carried forward into FIG. 5 and denoted by similar reference signs.

In the example shown in FIG. 5, an ongoing workflow 502 may interact with the device driver 112 to instantiate or initiate the filter pipeline 124. This ongoing workflow 502 may be performed in connection with an external process, relative to the device driver 112. Examples of the scenario shown in FIG. 5 may include the workflow 502 printing the document. Other examples may include scanning, faxing or retrieving a document from a disk based repository. In general, the workflows shown herein may involve document peripherals (e.g., printers, scanners, MFDs, fax machines, or the like).

The filter pipeline 124 may include one or more of the modular processing filters 116a-116n, as described above. In turn, one or more of these modular processing filters (e.g., 116b) may spawn or initiate one or more secondary workflows. FIG. 5 shows one example of an initiated workflow at 504. As described above, this initiated workflow 504 may include one or more workflow components, represented generally at 506. FIG. 5 shows two example workflow components at 506a and 506n, but implementations could include any number of workflow components.

In the example workflow shown in FIG. 5, the workflow 504 receives a document container, denoted at 126e, from the modular processing filter 116b that initiated the workflow. After the workflow 504 completes, it may return a document container 126f. In this manner, the modular processing filter 116b initiates the workflow 504, and then awaits completion of the workflow 504 before proceeding with the next modular processing filter (e.g., 116n).

FIG. 5 also shows another example of a secondary workflow 508, which may be initiated by the modular processing filter 116n. This initiated workflow 508 may receive as input a document container 126g. The workflow 508 may also include one or more workflow components, represented in FIG. 5 for convenience, but not limitation, at 510a and 510n (collectively, workflow 510). Additionally, the example workflow 510 may proceed in parallel with, and independently of, the filter 116n that initiated the workflow. As such, FIG. 5 includes a completion state 512, which represents a termination state of the workflow 508, without returning to the filter 116n.

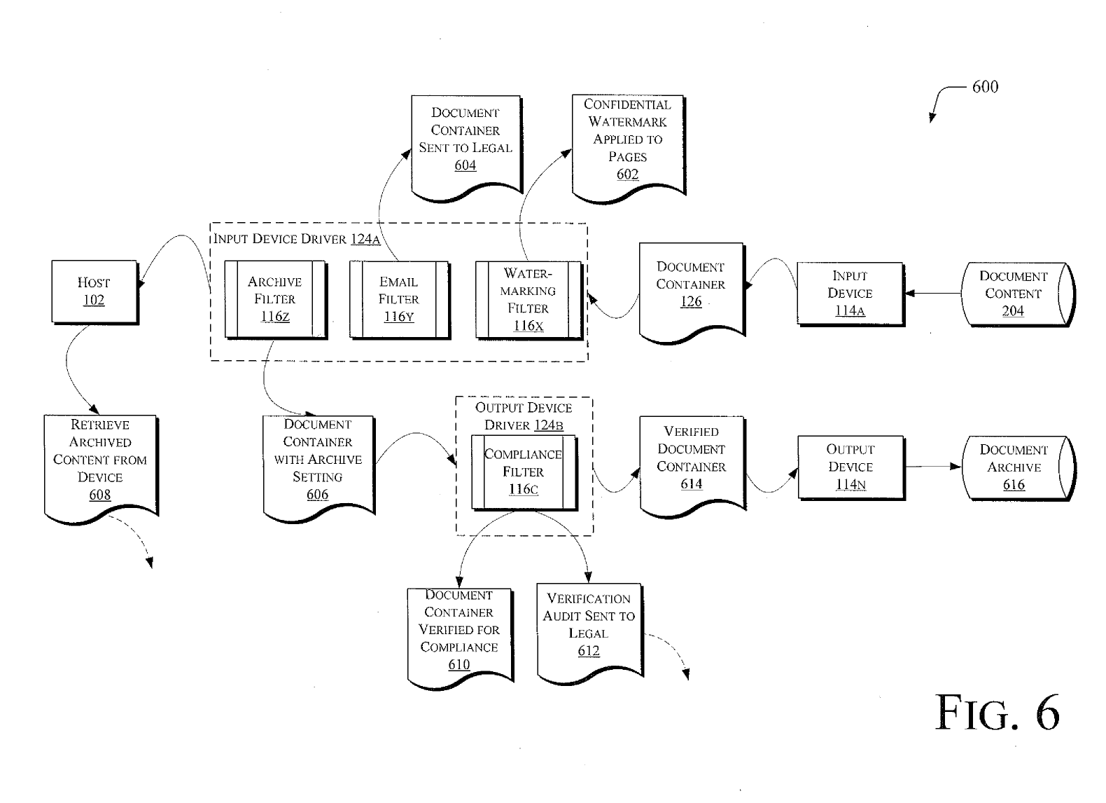

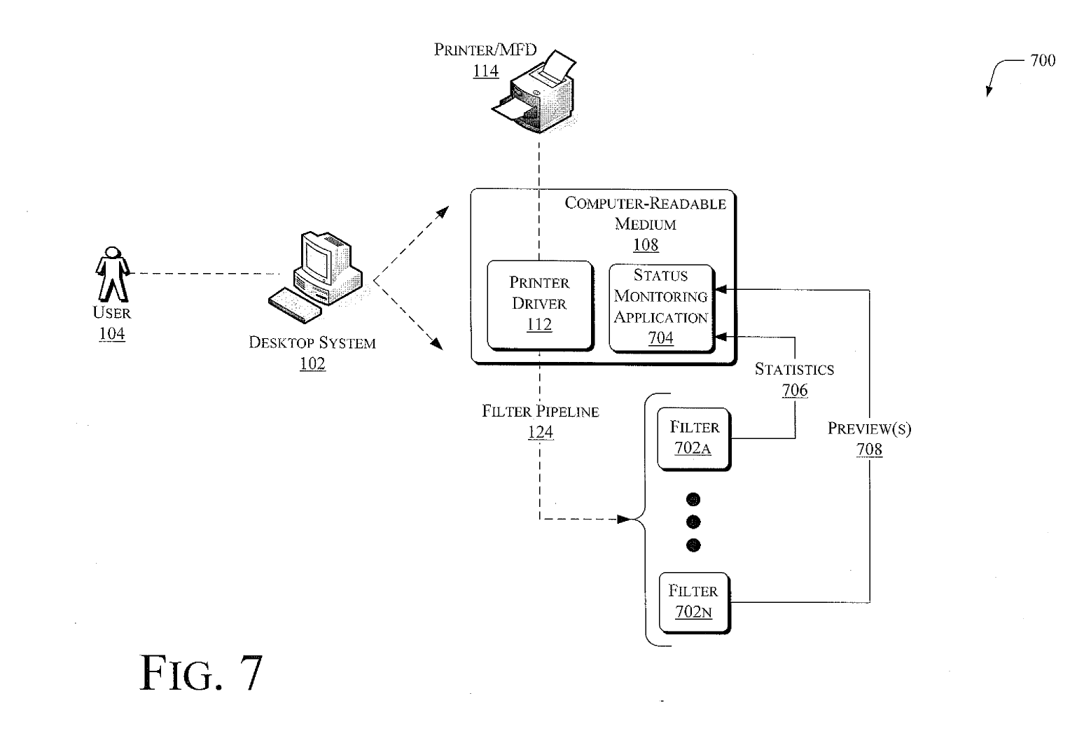

FIG. 6 illustrates additional operating environments 600 for performing document workflows and routing services using modular filters. For convenience of description, but not to limit possible implementations, some items described previously are carried forward into FIG. 6 and denoted by similar reference signs. In providing the example implementations shown in FIG. 6, it is noted that these implementations are illustrative rather than limiting.

An input device (e.g., 114a in FIG. 1) may read document content 204, and encapsulate the content into a document container 126. In turn, the document container may be transferred to the input device driver pipeline 124a for processing. The device driver pipeline 124a may include a watermarking filter 116x, an e-mail filter 116y, and an archive filter 116z. The document container is processed in turn by these filters in the input driver pipeline. Because the document container that is output by one filter can be understood as input to the next filter, all of these filters may interpret the document content.

The watermarking filter 116x may apply, for example, a “Company Confidential” watermark to the pages in the document, as represented generally by workflow component 602. This watermark may be applied based on a setting communicated from the device using a ticket package (e.g., at 206 in FIG. 2) that is embedded in the document container 126.

The email filter 116y may, for example, send the document to a legal department within an enterprise for additional workflow processing, which is represented generally by workflow component 604. This workflow may enable the legal department to track, store, and/or archive the content. Additionally, this workflow may enable the legal department to approve the content for further processing or distribution, or to sanitize (e.g., redact) the content before such processing or distribution.

The archive filter 116z may initiate an archive operation, which begins with workflow component 606 and is detailed further below. In addition, the filter 116z may return the document container to the host device (e.g., 102 in FIG. 1). Later, the host device may retrieve the archived content from the archive, as represented generally by workflow component 608.

As an independent workflow, the archive filter may send the document container with an updated ticket package to an output device for archiving, as represented generally by workflow component 606. An output driver pipeline 124b may include a single filter 116c for verifying that the document content complies with policies and procedures. A workflow component 610 verifies document compliance. Additionally, the filter 116c may initiate a new workflow 612 to send audit data to, for example, the legal department for verification.

The output pipeline 124b may send the document to an output device (e.g., 114n), as represented by workflow component 614. Based on the settings specified in, for example, a ticket package, the document may he archived in a device disk, as represented generally at 616.

FIG. 7 illustrates operating environments 700 for supporting workflows and routing services using modular filters. For convenience, but not limitation, some features described previously are carried forward to FIG. 7, and denoted by the same reference numbers.

In the example implementations shown in FIG. 7, the user 104 may interact with the device 102 to direct a print job to the printer 114, which in turn is associated with a corresponding printer driver 112. The printer driver 112 may instantiate a filter pipeline 124, which may include representative filters 702a and 702n (collectively, filters 702). The description of the filters 116 above applies equally to the filters 702, and the operating environments 700 may include any number of the filters 702.

The computer readable medium may include at least the printer driver 112 and a status monitoring application 704. In illustrating the status monitoring application, it is noted that some implementations of the description herein may omit the status monitoring application. As the print job proceeds, the job passes through the filters 702. As the individual filters 702 process their parts of the job, these filters may report back to the status monitoring application.

Turning to the filters 702 in more detail, the filter 702a may report statistical data 706 back to the status monitoring application. This statistical data 706 may reflect information such as the number of pages in the job, number of objects on the pages, and the like. Another filter 702n may provide intermediary previews 708 to the status monitoring application. For example, the filter 702n may provide previews or visibility into the states of an XML document container (e.g., at 126 in FIG. 1) as the document progresses through one or more stages of the filter pipeline 124.

### CONCLUSION

Although the systems and methods have been described in language specific to structural features and/or methodological acts, it is to be understood that the system and method defined in the appended claims is not necessarily limited to the specific features or acts described. Rather, the specific features and acts are disclosed as exemplary forms of implementing the claimed system and method.

In addition, regarding certain data and process flow diagrams described and illustrated herein, it is noted that the processes and sub-processes depicted therein may be performed in orders other than those illustrated without departing from the spirit and scope of the description herein. Also, while these data and process flows are described in connection with certain components herein, it is noted that these data and process flows could be performed with other components without departing from the spirit and scope of the description herein.

1. A machine-readable storage medium comprising machine-readable instructions that, when executed by the machine, cause the machine to perform a method comprising:
initiating a workflow from a first modular processing filter within a pipeline of modular processing filters, wherein the pipeline is included within a device driver; and
processing the workflow using at least a second processing filter within the pipeline.

2. The machine-readable storage medium of claim 1, wherein the instructions for initiating a workflow include instructions for initiating a workflow whose function is different than a function associated with the device driver.

3. The machine-readable storage medium of claim 1, wherein the instructions for initiating a workflow include instructions for initiating a workflow that completes without communicating back to the first processing filter.

4. The machine-readable storage medium of claim 1, further comprising instructions for passing a document container structure to the workflow.

5. The machine-readable storage medium of claim 1, wherein the instructions for initiating a workflow include instructions for initiating a workflow that proceeds independently of processing performed by the device driver, and in parallel with the processing performed by the device driver.

6. The machine-readable storage medium of claim 1, wherein the instructions for initiating a workflow include instructions for initiating a workflow that proceeds independently of processing performed by the device driver, and completes after processing performed by the device driver completes.

7. The machine-readable storage medium of claim 1, wherein the instructions for initiating a workflow include instructions for initiating a workflow that communicates back to the first processing filter after the workflow completes.

8. The machine-readable storage medium of claim 6, further comprising instructions for passing a first document container structure to the workflow, and further comprising instructions for receiving a second document container structure from the workflow.

9. A device comprising the machine-readable storage medium of claim 1.

10. A device driver comprising the machine-readable storage medium of claim 1.

11. A device driver comprising:
a plurality of modular processing filters for receiving a document container as input, and for passing at least part of the document container to the workflow.

12. The device driver of claim 11, wherein the processing filter is for initiating at least one workflow in response to an initiating workflow.

13. The device driver of claim 12, wherein the processing filter is for initiating the workflow as a secondary workflow to the initiating workflow.

14. The device driver of claim 11, wherein the processing filter is for initiating at least one workflow whose function is different than a function associated with the device driver.

15. The device driver of claim 11, wherein the processing filter is for initiating a workflow that proceeds independently of processing performed by the device driver, and in parallel with the processing performed by the device driver.

16. The device driver of claim 11, wherein the processing filter is for initiating a workflow that communicates back to the processing filter after the workflow completes.

17. The device driver of claim 11, wherein the processing filter is for initiating a workflow that completes without communicating back to the processing filter.

18. A machine-readable storage medium comprising machine-readable instructions that, when executed by the machine, cause the machine to perform a method comprising:
receiving a document container as input;
initiating a workflow; and
passing at least part of the document container to the workflow for processing.

19. The machine-readable storage medium of claim 18, wherein the instructions for initiating a workflow include instructions for initiating a workflow that communicates back upon completion.

20. The machine-readable storage medium of claim 18, wherein the instructions for initiating a workflow include instructions for initiating a workflow in response to interpreting a ticket package included in the document container.
